(19) United States
(12) Patent Application Publication
(10) Pub. No.: US 2009/0312069 A1
(43) Pub. Date: Dec. 17, 2009

(54) PORTABLE ELECTRONIC DEVICE WITH BROADCAST ANTENNA

(75) Inventors: Huang-Tse Peng, Taipei (TW); Kuo-Jen Lai, Taipei (TW); E-Den Hsiao, Taipei (TW)

Correspondence Address: KIRTON AND MCCONKIE, 60 EAST SOUTH TEMPLE,, SUITE 1800, SALT LAKE CITY, UT, 84111, US

(73) Assignee: ARIMA COMMUNICATIONS CO., LTD., Taipei County (TW)

(21) Appl. No.: 12/267,795

(22) Filed: Nov. 10, 2008

(30) Foreign Application Priority Data
Jun. 12, 2008 (TW) 097121987

(51) Int. Cl. H04B 1/38; H04W 88/02; H04M 1/00

(52) U.S. Cl. 455/572; 455/575.7

(57) ABSTRACT

The present invention is related to a portable electronic device with broadcast antenna at least including a main body having a battery accommodating space; a cover having a battery area corresponding to the battery accommodating space of the main body, wherein the shape and size of the cover are adapted to cover the battery accommodating space and the cover is separablely assembled with the corresponding outer edge of the battery accommodating space of the main body; and a broadcast antenna, disposed on the inner surface of the cover other than the battery area for unidirectionally receiving broadcasting signals in a first frequency band.

### FIELD OF THE INVENTION

The present invention is related to a portable electronic device, and more particularly to a portable electronic device with broadcast antenna.

### BACKGROUND OF THE INVENTION

In recent years, the development of the wireless communication industry is vigorous. Especially, some portable wireless communication electronic devices, for example, cell phones or PDAs, have become indispensable commodities for people. An antenna generally plays an important role for transmitting and receiving wireless signals in a portable wireless communication electronic device. Therefore, the operating characteristics of the antenna have a direct impact on the transmission and receiving quality for the portable wireless communication electronic device.

Nowadays, owing to the miniaturization of the portable wireless communication electronic device and the improvement of portability thereof, the antenna in the portable wireless communication electronic device, except for having good characteristic, also has to become smaller. Although there is no path length limitation to antenna, for maintaining a normal operation, the path length still has to be longer than quarter wavelength (λ) of wireless signal. The wavelength of wireless signals is approximately identical to the light velocity divided by the frequency of wireless signal. Accordingly, GSM 900 (Global System for Mobile Communications 900) whose frequency is ranged from 880 to 960 MHz will have a wavelength (λ) of 35˜32 cm, and FM (Frequency Modulation) broadcast whose frequency is ranged from 87 to 108 MHz will have a wavelength (λ) of 354˜285 cm.

Since quarter wavelength (λ/4) of GSM 900 is approximately identical to 8.75 cm and quarter wavelength (λ/4) of FM broadcast is almost identical to 88.5 cm, the volume of the portable wireless communication electronic device which possesses the functions of GSM 900 and FM broadcast at the same time must become larger. For solving this problem, the traditional portable wireless communication electronic device installs the GSM 900 antenna in the housing thereof and leaves the FM antenna outside. For example, FIG. 1 shows the conventional portable wireless communication electronic device with outside broadcast antenna, in which the earphone is used as the outside FM antenna, and FIG. 2 shows the conventional portable wireless communication electronic device with telescopic broadcast antenna, wherein through utilizing the telescopic FM antenna, the volume of portable wireless communication electronic device can be reduced as leaving the FM function idle.

In the conventional portable wireless communication electronic device in which earphone is served as FM antenna for reducing the volume, since earphone is not a dedicated antenna, the return loss, bandwidth and performance thereof are not qualified, and further, the different earphone choices by users also might influence the quality of the received FM wireless broadcasting signals. As to the portable wireless communication electronic device with telescopic antenna, since the antenna thereof has to be expanded to a specific length, such as the longest length, for achieving the qualified return loss, bandwidth and performance, the antenna might be easily damaged owing to the frequent expansion and contraction operations, and further, the shape of the portable wireless communication electronic device might also be limited thereby.

Therefore, how to develop a portable electronic device with broadcast antenna which can solve the drawbacks in the prior art is really an urgent demand.

### SUMMARY OF THE INVENTION

An object of the present invention is to provide a portable electronic device with broadcast antenna which is divided into two parts, a main body and a separable cover, wherein the broadcast antenna is disposed on the inner surface of the cover other than a battery area, so that the broadcast antenna with longer path length can be accommodated in the housing of the portable electronic device. Therefore, the portable electronic device with broadcast antenna according to the present invention can have a dedicated broadcast antenna with qualified return loss, bandwidth and performance, and thus, the quality of received broadcasting signals becomes more stable and better.

Another object of the present invention is to provide a portable electronic device with broadcast antenna which is divided into two parts, a main body and a separable cover, wherein the broadcast antenna is disposed on the inner surface of the separable cover, so that it does not need to keep away from numerous components of the main body, such as, image gathering lens, circuit board, image frame grabber, displayer, input keyboard, speaker and microphone, and accordingly, the design for the broadcast antenna becomes easier, and further, as assembling the broadcast antenna to the cover, the operation also can be simplified.

For achieving the objects described above, a preferred embodiment of the present invention is provided as a portable electronic device with broadcast antenna at least including a main body having a battery accommodating space; a cover having a battery area corresponding to the battery accommodating space of the main body, wherein the shape and size of the cover are adapted to cover the battery accommodating space and the cover is separablely assembled with the corresponding outer edge of the battery accommodating space of the main body; and a broadcast antenna, disposed on the inner surface of the cover other than the battery area for unidirectionally receiving broadcasting signals in a first frequency band.

The above contents of the present invention will become more readily apparent to those ordinarily skilled in the art after reviewing the following detailed description and accompanying drawings, in which:

### BRIEF DESCRIPTION OF THE DRAWINGS

FIG. 1 shows a conventional portable wireless communication electronic device with outside broadcast antenna;

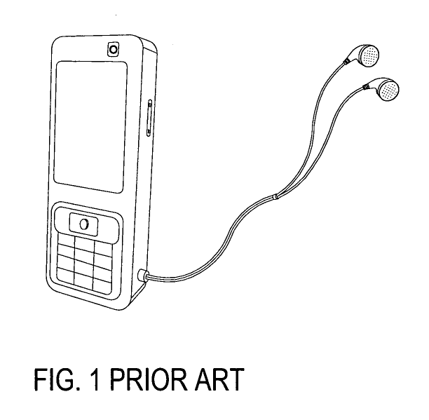

FIG. 2 shows a conventional portable wireless communication electronic device with telescopic broadcast antenna;

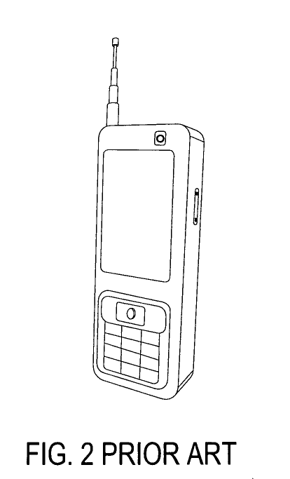

FIG. 3 shows a schematic view of a portable electronic device with broadcast antenna in a preferred embodiment of the present invention;

FIG. 4 shows a characteristic plot of the standing-wave ratio versus frequency relationship of the broadcast antenna in FIG. 3; and

FIG. 5 shows a schematic view of a portable electronic device with broadcast antenna in another preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

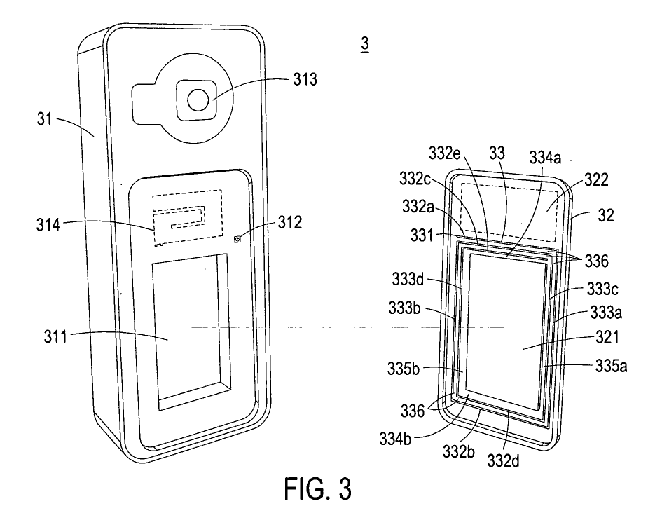

Referring to FIG. 3, a schematic view of a portable electronic device with broadcast antenna in a preferred embodiment of the present invention is shown. As shown, the portable electronic device 3 with broadcast antenna of the present invention includes a main body 31, a cover 32 and a broadcast antenna 33. The main body 31 has a battery accommodating space 311 for disposing battery (not shown). The cover 32, such as battery cover, has a battery area 321 corresponding to the battery accommodating space 311, and the shape and size of the cover 32 are adapted to cover the battery accommodating space 311, wherein the cover 32 can be separably assembled with the corresponding outer edge of the battery accommodating space 311 of the main body 31. The broadcast antenna 33 is located on the cover 32 at the area other than the battery area 321, so as to receive the wireless broadcasting signals in a first frequency band, wherein the broadcast antenna 33 can be made of FPCB (Flexible Printed Circuit Board) for providing flexibility, so that the broadcast antenna 33 can be easily disposed on the inner surface of the cover 32 without being limited by the curved sidewalls of the accommodating space.

In this embodiment, the broadcast antenna 33 includes a feeding point 331, a first transverse section 332a, a second transverse section 332b, a third transverse section 332c, a fourth transverse section 332d, a fifth transverse section 332e, a first longitudinal section 333a, a second longitudinal section 333b, a third longitudinal section 333c and a fourth longitudinal section 333d, wherein the feeding point 331 is disposed at one end of the first transverse section 332a, the other end of the first transverse section 332a is connected to one end of the first longitudinal section 333a, the other end of the first longitudinal section 333a is connected to one end of the second transverse section 332b, the other end of the second transverse section 332b is connected to one end of the second longitudinal section 333b, the other end of the second longitudinal section 333b is connected to one end of the third transverse section 332c, the other end of the third transverse section 332c is connected to one end of the third longitudinal section 333c, the other end of the third longitudinal section 333c is connected to one end of the fourth transverse section 332d, the other end of the fourth transverse section 332d is connected to one end of the fourth longitudinal section 333d, and the other end of the fourth longitudinal section 333d is connected to one end of the fifth transverse section 332e, thereby forming a ring-shaped broadcast antenna around the battery area 321 of the cover 32.

Moreover, the battery area 321 and the fifth transverse section 332e is separated by a first transverse interval 334a, the battery area 321 and the fourth transverse section 332d is separated by a second transverse interval 334b, the battery area 321 and the third longitudinal section 333c is separated by a first longitudinal interval 335a, and the battery area 321 and the fourth longitudinal section 333d is separated by a second longitudinal interval 335b, thereby ensuring that the characteristic of antenna will not be influenced by the metal contained in the battery (not shown). Besides, among multiple rings of the ring-shaped antenna formed by the first transverse section 332a, the second transverse section 332b, the third transverse section 332c, the fourth transverse section 332d, the fifth transverse section 332e, the first longitudinal section 333a, the second longitudinal section 333b, the third longitudinal section 333c and the fourth longitudinal section 333d, section intervals 336 are located for separation. In this embodiment, the first transverse interval 334a and the second transverse interval 334b respectively have a distance of 3.5 mm to the battery area 32, the first longitudinal interval 335a and the second longitudinal interval 335b respectively have a distance of 2 mm to battery area 321, the section intervals 336 respectively have a width of 3 mm, the first transverse section 332a and the second transverse section 332b respectively have a length of 45 mm, and the first longitudinal section 333a and the second longitudinal section 333b respectively have a length of 62 mm.

In this embodiment, the main body 31 further includes a broadcast antenna connecting terminal 312, an image gathering lens 313 and a communication antenna 314. The broadcast antenna connecting terminal 312 is disposed at the position corresponding to the feeding point 331 of the broadcast antenna 33, such that the broadcast antenna connecting terminal 312 can be contacted with the feeding point 331 of the broadcast antenna 33 in a selectable and separable manner. When the cover 32 is assembled with the main body 31, the feeding point 331 of the broadcast antenna 33 will be connected with the broadcast antenna connecting terminal 312, so that the wireless broadcasting signals unidirectionally received by the broadcast antenna 33, such as FM broadcasting signals, AM (Amplitude Modulation) broadcasting signals, or television broadcasting signals, can be transmitted to the circuit board (not shown) in the main body 31, and thus, the portable electronic device 3 with broadcast antenna according to the present invention can play audio and video broadcasts. The image gathering lens 313 is disposed at one side of the main body 31 for gathering image. The communication antenna 314 is disposed on the main body 31 for bidirectionally transmitting and receiving the wireless communication signals in a second frequency band, which is higher than the first frequency band, such as wireless communication signals of GSM 900, GSM 850, DCS (Digital Communication System), PCS (Personal Communications Service), and WCDMA (Wideband Code Division Multiple Access) whose frequency bands are respectively and approximately located at 880˜960 MHz, 824˜894 MHz, 1710˜1880 MHz, 1850˜1990 MHz and 1920˜2170 MHz. Since the frequency of the second frequency band is apparently higher than that of the first frequency band, the path length of the communication antenna 314 is shorter than that of the broadcast antenna 33, so that the communication antenna 314 can be easily disposed inside the housing of the main body 31. In this embodiment, the communication antenna 314 is disposed in the region which can be covered by the cover 32, and the cover 32 correspondingly has a communication antenna area 322. It should be noted that except the batter area 321, the broadcast antenna 33 also should not be disposed in the communication antenna area 322 for avoiding the communication antenna 314 from being shielded by broadcast antenna 33.

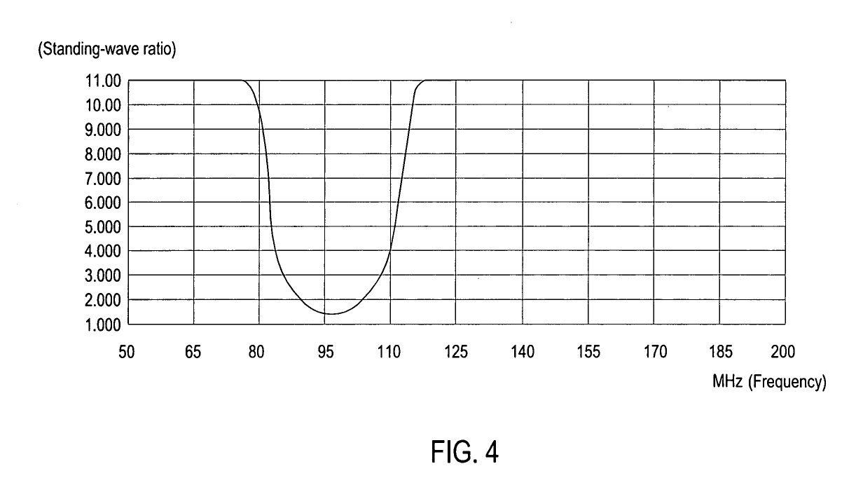

Referring to FIG. 4, a characteristic plot of the standing-wave ratio versus frequency relationship is shown. As shown, the longitudinal axis represents the SWR (Standing-Wave Ratio) that shows a linear relationship with the gain value of the return loss. In addition, the standing-wave ratio can be converted into the gain value of the return loss through computations. It is noted that the standing-wave ratio will vary with the frequency. Generally, if the antenna has a standing-wave ratio below 3 under a frequency band, it indicates that the antenna performs well under that frequency band. Hence, it can be understood from FIG. 4 that since the first frequency band of the broadcast antenna 33 of FIG. 3 is located at 87.5˜108.5 MHz, it can unidirectionally receive the FM wireless broadcasting signals in a lower frequency band, such as frequency bands under 1 GHz. In some embodiments, the first frequency band can be designed to be 520˜1710 MHz for AM wireless broadcasting signals, or it also can be designed to be the frequency bands used by analog or digital television broadcasting signals, such as 76˜88 MHz, 174˜210 MHz or 470˜860 MHz, for respectively receiving AM broadcasting signals and television broadcasting signals. Therefore, the first frequency band of the broadcast antenna 33 can be low-frequency band for AM broadcast, FM broadcast, and analog or digital television broadcast.

In this embodiment, the circuit board (not shown) of the main body 31 includes broadcasting signal demodulation circuit, image frame grabber, displayer, input keyboard, speaker and microphone. The broadcasting signal demodulation circuit is connected to the broadcast antenna 33 through the broadcast antenna connecting terminal 312 for receiving broadcasting signals, and after demodulating the broadcasting signals, the video broadcasts can be obtained. The image frame grabber is disposed at a position corresponding to the image gathering lens 313 for gathering images through the image gathering lens 313. The displayer is used to display image messages, such as picture or animation.

The broadcast antenna 33 of the portable electronic device 3 with broadcast antenna according to the present invention is located at the area on the cover 32 other than the battery area 321. The shape and position of the broadcast antenna 33 are not limited to surround the battery area 321 of the cover 32 for forming a ring-shaped antenna, and alternatively, the broadcast antenna also can be disposed at the outside of at least one side of the battery area 321 in a manner of transversely or longitudinally traveling back and forth without forming any particular shape.

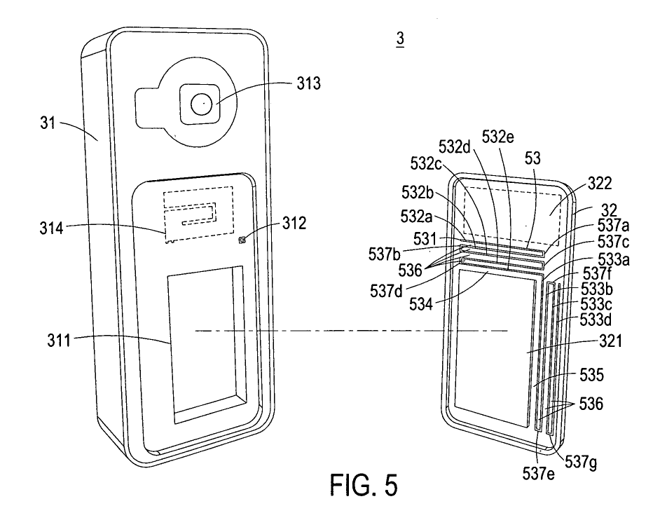

Referring to FIG. 5, a schematic view of a portable electronic device with broadcast antenna in another preferred embodiment of the present invention is shown. As shown, the difference between the portable electronic devices with broadcast antenna in FIG. 5 and FIG. 3 is the different shapes and disposing positions of the broadcast antenna 53 and the broadcast antenna 33. In this embodiment, the broadcast antenna 53 includes a feeding point 531, a first transverse section 532a, a second transverse section 532b, a third transverse section 532c, a fourth transverse section 532d, a fifth transverse section 532e, a first longitudinal section 533a, a second longitudinal section 533b, a third longitudinal section 533c, a fourth longitudinal section 533d, a first connecting section 537a, a second connecting section 537b, a third connecting section 537c, a fourth connecting section 537d, a fifth connecting section 537e, a sixth connecting section 537f, and a seven connecting section 537g, wherein the first transverse section 532a, the second transverse section 532b, the third transverse section 532c, the fourth transverse section 532d, the fifth transverse section 532e, the first connecting section 537a, the second connecting section 537b, the third connecting section 537c, and the fourth connecting section 537d are located at the outside of one side of the battery area 321 on the cover 32 and keeps away from the communication antenna area 322. Furthermore, the first longitudinal section 533a, the second longitudinal section 533b, the third longitudinal section 533c, the fourth longitudinal section 533d, the fifth connecting section 537e, the sixth connecting section 537f, and the seven connecting section 537g are located at the outside of another side of the battery area 321 on the cover 32.

The feeding point 531 is disposed at one end of the first transverse section 532a, and when the cover 32 is assembled with the main body 31, the feeding point 531 will be connected with the broadcast antenna connecting terminal 312, so that the wireless broadcasting signals received by the broadcast antenna 53 can be transmitted to the circuit board (not shown) in the main body 31. In this embodiment, the connecting sequence of the broadcast antenna 53 is the first transverse section 532a, the first connecting section 537a, the second transverse section 532b, the second connecting section 537b, the third transverse section 532c, the third connecting section 537c, the fourth transverse section 532d, the fourth connecting section 537d, the fifth transverse section 532e, the first longitudinal section 533a, the fifth connecting section 537e, the second longitudinal section 533b, the sixth connecting section 537f, the third longitudinal section 533c, the seven connecting section 537g, and the fourth longitudinal section 533d.

Besides, among the first transverse section 532a, the second transverse section 532b, the third transverse section 532c, the fourth transverse section 532d, and the fifth transverse section 532e, section intervals 536 are located. Identically, among the first longitudinal section 533a, the second longitudinal section 533b, the third longitudinal section 533c, and the fourth longitudinal section 533, sectional intervals 536 are also located. In addition, the battery area 321 and the fifth transverse section 532e is separated by a first transverse interval 534, and the battery area 321 and the first longitudinal section 533a is separated by a first longitudinal interval 535. In this embodiment, the first transverse interval 534 substantially has a width of 3.5 mm, the first longitudinal interval 535 substantially has a width of 2 mm, the section intervals 536 respectively have a width of 3 mm, the first transverse section 532a, the second transverse section 532b, the third transverse section 532c, the fourth transverse section 532d, and the fifth transverse section 532e respectively have a length of 45 mm, and the first longitudinal section 533a, the second longitudinal section 533b, the third longitudinal section 533c, and the fourth longitudinal section 533d respectively have a length of 62 mm.

Of course, the shape and position of the broadcast antenna are not limited to FIG. 3 and FIG. 5 and can be modified in other embodiments, and further, the number of sections and the disposed pattern also can be varied in accordance with different demands.

In the aforesaid, the present invention provides a portable electronic device with broadcast antenna which is divided into two parts: a main body and a separable cover, wherein the broadcast antenna is disposed on the inner surface of the cover other than a battery area, so that the broadcast antenna with longer path length can be accommodated in the housing of the portable electronic device. Therefore, the portable electronic device with broadcast antenna according to the present invention can have a small volume and simultaneously possess a dedicated broadcast antenna with qualified return loss, bandwidth and performance, and thus, the quality of received broadcasting signals becomes more stable and better. In addition, since the broadcast antenna is disposed on the inner surface of the separable cover, it does not need to keep away from numerous components of the main body, such as, image gathering lens, circuit board, image frame grabber, displayer, input keyboard, speaker and microphone, and accordingly, the design for the broadcast antenna becomes easier, and further, as assembling the broadcast antenna to the cover, the operation also can be simplified.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A portable electronic device with broadcast antenna, comprising:
a main body having a battery accommodating space;
a cover having a battery area corresponding to the battery accommodating space of the main body, wherein the shape and size of the cover are adapted to cover the battery accommodating space and the cover is separablely assembled with the corresponding outer edge of the battery accommodating space of the main body; and
a broadcast antenna disposed on the inner surface of the cover other than the battery area for unidirectionally receiving broadcasting signals in a first frequency band.

2. The portable electronic device according to claim 1 wherein the broadcasting signals are Frequency Modulation broadcasting signals, Amplitude Modulation broadcasting signals, analog television broadcasting signals or digital television broadcasting signals.

3. The portable electronic device according to claim 1 wherein the first frequency band includes frequency bands of Frequency Modulation broadcast, Amplitude Modulation broadcast, analog television or digital television broadcast.

4. The portable electronic device according to claim 1 wherein the main body further includes a communication antenna disposed in the main body for bidirectionally transmitting and receiving communication signals in a second frequency band.

5. The portable electronic device according to claim 4 wherein the second frequency band includes frequency bands of GSM 900 (Global System for Mobile Communications 900), GSM 850 (Global System for Mobile Communications 850), DCS (Digital Communication System), PCS (Personal Communications Service), and WCDMA (Wideband Code Division Multiple Access).

6. The portable electronic device according to claim 4 wherein the cover further includes a communication antenna area located at a position corresponding to the communication antenna, and the broadcast antenna is disposed on the cover other than the communication antenna area and the battery area.

7. The portable electronic device according to claim 4 wherein the first frequency band has a lower frequency than that of the second frequency band.

8. The portable electronic device according to claim 1 wherein the broadcast antenna and the battery area have a first transverse interval and a first longitudinal interval.

9. The portable electronic device according to claim 8 wherein the first transverse interval has a width of 3.5 mm, and the first longitudinal interval have a width of 2 mm.

10. The portable electronic device according to claim 1 wherein the broadcast antenna further includes a feeding point and the main body further includes a broadcast antenna connecting terminal located at a position corresponding thereto, and the broadcast antenna connecting terminal is contacted with the feeding point in a selectable and separable manner.

11. The portable electronic device according to claim 1 wherein the broadcast antenna is disposed around the battery area for forming a ring shape or disposed at the outside of at least one side of the battery area in a manner of transversely or longitudinally traveling back and forth.

12. The portable electronic device according to claim 11 wherein the broadcast antenna further includes a first transverse section, a second transverse section, a third transverse section, a fourth transverse section, a fifth transverse section, a first longitudinal section, a second longitudinal section, a third longitudinal section and a fourth longitudinal section.

13. The portable electronic device according to claim 12 wherein the connecting sequence of the broadcast antenna is the first transverse section, the first longitudinal section, the second transverse section, the second longitudinal section, the third transverse section, the third longitudinal section, the fourth transverse section, the fourth longitudinal section, and the fifth transverse section.

14. The portable electronic device according to claim 12 wherein a section interval is respectively located among the ring-shaped antenna formed by the first transverse section, the second transverse section, the third transverse section, the fourth transverse section, the fifth transverse section, the first longitudinal section, the second longitudinal section, the third longitudinal section and the fourth longitudinal section for separation.

15. The portable electronic device according to claim 12 wherein the broadcast antenna further includes a first connecting section, a second connecting section, a third connecting section, a fourth connecting section, a fifth connecting section, a sixth connecting section, and a seven connecting section.

16. The portable electronic device according to claim 15 wherein the connecting sequence of the broadcast antenna is the first transverse section, the first connecting section, the second transverse section, the second connecting section, the third transverse section, the third connecting section, the fourth transverse section, the fourth connecting section, the fifth transverse section, the first longitudinal section, the fifth connecting section, the second longitudinal section, the sixth connecting section, the third longitudinal section, the seven connecting section, and the fourth longitudinal section.

17. The portable electronic device according to claim 16 wherein the first transverse section, the second transverse section, the third transverse section, the fourth transverse section, the fifth transverse section, the first connecting section, the second connecting section, the third connecting section, and the fourth connecting section of the broadcast antenna are located at the outside of one side of the battery area on the cover, and the first longitudinal section, the second longitudinal section, the third longitudinal section, the fourth longitudinal section, the fifth connecting section, the sixth connecting section, and the seven connecting section of the broadcast antenna are located at the outside of another side of the battery area on the cover.

18. The portable electronic device according to claim 12 wherein the first transverse section and the second transverse section of the broadcast antenna respectively have a length of 45 mm, and the first longitudinal section and the second longitudinal section of the broadcast antenna respectively have a length of 62 mm.
